(19) United States
(12) Patent Application Publication
(10) Pub. No.: US 2017/0090379 A1
(43) Pub. Date: Mar. 30, 2017

(54) TARGET RECORDING MEDIUM FEEDING APPARATUS, IMAGE FORMING APPARATUS AND TARGET RECORDING MEDIUM CUTTING CONTROL METHOD

(71) Applicant: CASIO COMPUTER CO., LTD., Tokyo (JP)

(72) Inventors: Toshiaki Yajima, Iruma-shi (JP); Toshio Nagasaka, Iruma-shi (JP)

(21) Appl. No.: 15/241,296

(22) Filed: Aug. 19, 2016

(30) Foreign Application Priority Data
Sep. 24, 2015 (JP) 2015-186624

(51) Int. Cl. G03G 15/00

(52) U.S. Cl. CPC G03G 15/6523

(57) ABSTRACT

A paper conveyance roller pair on the lower flow side of an auto cutter which cuts a target recording medium (long paper) at predetermined timing during a printing operation includes a powder brake mechanism which brakes the paper conveyance roller pair by changing the degree of agglomeration of magnetic powder with a magnetic force generated by a coil based on an excitation current value so as to continuously vary a transmission torque. When the target recording medium is cut, a control section varies an excitation current of the power brake mechanism to increase a load torque to be applied to the paper conveyance roller pair, and applies tension larger than usual to the target recording medium pinched by the paper conveyance roller pair.

### CROSS-REFERENCE TO RELATED APPLICATION

This application is based upon and claims the benefit of priority from the prior Japanese Patent Application No.

2015-186624, filed Sep. 24, 2015, the entire contents of which are incorporated herein by reference.

### BACKGROUND OF THE INVENTION

1. Field of the Invention

The present invention relates to a target recording medium feeding apparatus, an image forming apparatus and a target recording medium cutting control method.

2. Description of the Related Art

Conventionally, in an electrophotographic image forming apparatus, a photosensitive drum in a developing device is initialized by being equally charged, and a latent image is formed by optical writing on the photosensitive drum, changed (developed) into a toner image, secondarily transferred to a target recording medium, and fixed thereto by a fixing device.

In the above-described image forming apparatus, in a case where long paper is used as a target recording medium, the long paper needs to be cut at an arbitrary position at the end timing of a print job. In this conventional image forming apparatus, the long paper is cut with it being curved between a pair of conveyance rollers (target recording medium pinching sections) so as not to affect an operation in a secondary transfer section on the lower flow side than the cutting position.

For example, a technique has been proposed in which clutch means for transmitting a rotational force in only a conveyance direction of long paper is provided between driving means for rotating a paper feeding roller and the paper feeding roller so as to control a period of time that elapses until the paper feeding roller rotating through inertia by the clutch means stops and a period of time that elapses until the long paper decelerates and stops when the long paper is cut.

### SUMMARY OF THE INVENTION

In accordance with one aspect of the present invention, there is provided a target recording medium feeding apparatus which feeds a target recording medium to an image forming section, comprising: a cutting section which cuts the target recording medium at a predetermined position in a conveyance path through which the target recording medium is conveyed; a load application section which applies load tension to the target recording medium on a lower flow side of the predetermined position in the conveyance path; and an adjustment section which adjusts the load tension in a manner to correspond to cut timing.

In accordance with another aspect of the present invention, there is provided a target recording medium feeding apparatus which feeds a target recording medium to an image forming section, comprising: a cutting section which cuts the target recording medium at a predetermined position in a conveyance path through which the target recording medium is conveyed; a target recording medium pinching section which pinches the target recording medium on a lower flow side of the predetermined position in the conveyance path, and rotates while being driven by the conveyed target recording medium; a load application section which applies a load torque to driven rotation of the target recording medium; and an adjustment section which adjusts the load torque in a manner to correspond to cut timing.

In accordance with another aspect of the present invention, there is provided an image forming apparatus comprising: a cutter which cuts a target recording medium at a predetermined position in a conveyance path through which the target recording medium is conveyed; a conveyance roller pair which pinches the target recording medium on a lower flow side of the predetermined position in the conveyance path, and rotates while being driven by the conveyed target recording medium; a powder brake which applies a load torque based on an excitation current to driven rotation of the conveyance roller pair; and a current adjustment device which adjusts the excitation current in a manner to correspond to cut timing.

In accordance with another aspect of the present invention, there is provided a target recording medium cutting control method for cutting a target recording medium, comprising: a step of cutting the target recording medium at a predetermined position in a conveyance path through which the target recording medium is conveyed, by a cutting section; and a step of adjusting tension of the target recording medium to be applied on a lower flow side of the predetermined position in the conveyance path in a manner to correspond to cut timing.

In accordance with another aspect of the present invention, there is provided a target recording medium cutting control method for cutting a target recording medium to be fed to an image forming section, comprising: a step of cutting the target recording medium at a predetermined position in a conveyance path through which the target recording medium is conveyed, by using a cutter; and a step of pinching the target recording medium on a lower flow side of the predetermined position in the conveyance path, and adjusting an excitation current of a powder brake which applies a load torque based on the excitation current to a conveyance roller pair which rotates while being driven by the conveyed target recording medium, in a manner to correspond to cut timing.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an entire conceptual diagram showing a front view of an image forming apparatus 10 for printing on long paper or a cut sheet according to an embodiment of the present invention;

FIG. 2 is an upper view showing the structure of a long paper feeding section 15 in the image forming apparatus 10 according to the present embodiment;

FIG. 3 is a block diagram showing a partial structure of a control system in the image forming apparatus 10 according to the present embodiment;

FIG. 4 is a flowchart for explaining an operation (cutting operation) of the image forming apparatus 10 according to the present embodiment; and

FIG. 5 is a timing chart for explaining the operation (cutting operation) of the image forming apparatus 10 according to the present embodiment.

### DETAILED DESCRIPTION OF THE PREFERRED EMBODIMENT

An embodiment of the present invention will hereinafter be described with reference to the drawings.

### A. Configuration of Embodiment

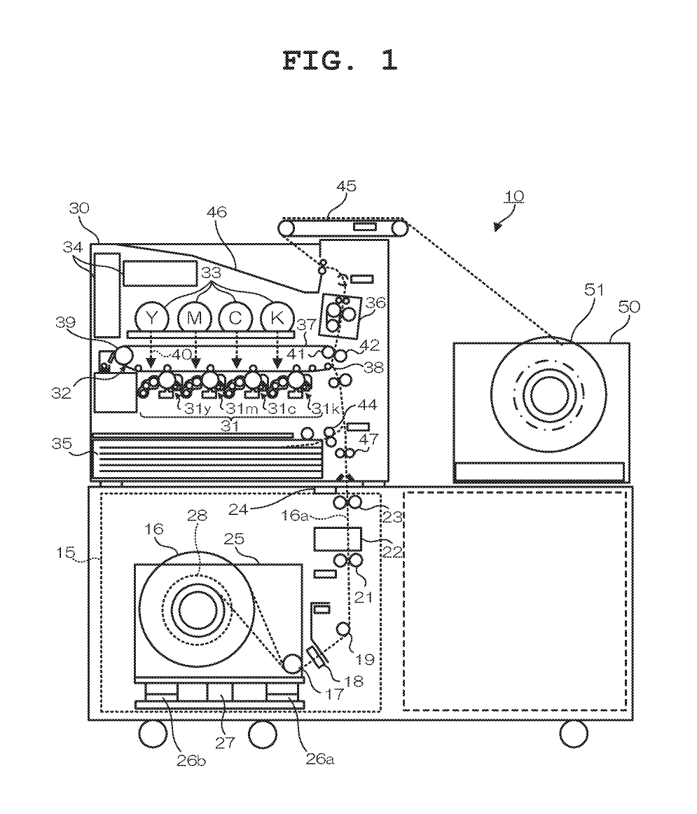

FIG. 1 is an entire conceptual diagram of an image forming apparatus 10 for printing on long paper or a cut sheet according to an embodiment of the present invention. In FIG. 1, the image forming apparatus 10 includes a long paper feeding section 15, an image forming section 30, and a long paper winding section 50. The long paper feeding section 15 is installed below the main body of the image forming section 30, and a paper feeding roll 16 is placed therein. A paper guide roller 17 in FIG. 1 changes a conveyance direction of a target recording medium (long paper) 16a wound off the paper feeding roll 16 so as to guide the target recording medium (long paper) 16a such that the target recording medium (long paper) 16a is conveyed toward the image forming section 30 located above.

An edge sensor 18 in FIG. 1 is arranged between the paper guide roller 17 and a paper guide roller 19 described below, and detects respective positions at both edges in a paper width direction perpendicular to the conveyance direction of the target recording medium (long paper) 16a wound off the paper feeding roll 16. Note that two edge sensors 18 are respectively arranged at both edges of the target recording medium (long paper) 16a as described below although only one edge sensor 18 is shown in FIG. 1. The edge sensor 18 detects skew of the target recording medium (long paper) 16a from the detected positions at both edges in the paper width direction of the target recording medium (long paper) 16a.

The paper guide roller 19 changes the conveyance direction of the target recording medium (long paper) 16a which has passed through the edge sensor 18, and guides the target recording medium (long paper) 16a such that the target recording medium (long paper) 16a is conveyed toward the image forming section 30 located above. A lower paper conveyance roller pair 21 and an upper paper conveyance roller pair 23 in FIG. 1 hold the target recording medium (long paper) 16a delivered from the paper feeding roll 16 from both sides, and convey the target recording medium (long paper) 16a toward the image forming section 30 located above. Here, at least one roller in each of the lower paper conveyance roller pair 21 and the upper paper conveyance roller pair 23 includes a clutch mechanism. A driving force from a rotational axis of the paper feeding roll 16 is transmitted to the roller when the clutch mechanism is turned on, and is cut when the clutch mechanism is turned off so that the roller is driven by the target recording medium (long paper) 16a.

When printing is started, the target recording medium (long paper) 16a is conveyed into the image forming section 30, and the respective clutch mechanisms in the lower paper conveyance roller pair 21 and the upper paper conveyance roller pair 23 are turned off (disengaged) at timing at which the target recording medium (long paper) 16a is pinched by a conveyance roller (a main body approach conveyance roller 47 and the like described below) in the image forming section 30. After the respective clutch mechanisms in the lower paper conveyance roller pair 21 and the upper paper conveyance roller pair 23 are turned off, the target recording medium (long paper) 16a is conveyed by the conveyance roller (the main body approach conveyance roller 47 and the like described below) in the image forming section 30, and the lower paper conveyance roller pair 21 and the upper paper conveyance roller pair 23 are driven by the conveyed target recording medium (long paper) 16a.

Also, in the present embodiment, the upper paper conveyance roller pair 23 includes a powder brake mechanism in addition to the above-described clutch mechanism. This powder brake mechanism brakes (at least one roller in) the upper paper conveyance roller pair 23 by changing the degree of agglomeration of magnetic powder with a magnetic force generated by a coil in response to an excitation current value and thereby continuously varying a transmission torque. By the powder brake mechanism, a load torque (tension to the target recording medium (long paper) 16a) to be applied to the upper paper conveyance roller pair 23 is controlled.

An auto cutter 22 in FIG. 1 cuts the target recording medium (long paper) 16a when the paper feeding roll 16 is placed to feed the target recording medium (long paper) 16a or when the printing is ended. A paper passage sensor 24 in FIG. 1 detects the passage of the front edge or the rear edge of the target recording medium (long paper) 16a to be conveyed to the image forming section 30.

An unwinder 25 in FIG. 1 in which the paper feeding roll 16 is placed and the paper guide roller 17 are arranged on separate frames in the long paper feeding section 15, which are movable in the paper width direction by slide bearings 26a and 26b. In an area under the unwinder 25, for example, an actuator 27 which is expanded and contracted by an electromagnetic force is arranged. By the actuator 27 being expanded and contracted, the unwinder 25 on slide bearings 26a and 26b can be moved in the paper width direction. Also, a powder brake 28 is fixed to the rotational axis of the paper feeding roll 16. This powder brake 28 applies a predetermined brake to the rotational axis of the paper feeding roll 16 so as to control the tension of the target recording medium (long paper) 16a.

Also, the long paper feeding section 15 includes a conveyance motor (not shown) for driving the conveyance roller pairs (the lower paper conveyance roller pair 21 and the upper paper conveyance roller pair 23) which feed the target recording medium (long paper) 16a wound off the paper feeding roll 16. The conveying motor is controlled to be driven when the target recording medium (long paper) 16a is fed from the paper feeding roll 16. In the present embodiment, when the target recording medium (long paper) 16a is cut, a conveyance motor (not shown) is controlled to be driven so as to control the feeding line speed of the target recording medium (long paper) 16a from the paper feeding roll 16.

Note that, during a normal printing operation, the target recording medium (long paper) 16a wound off the paper feeding roll 16 is conveyed with predetermined tension being retained by it being wrapped around the conveyance roller (the main body approach conveyance roller 47, etc.) in the image forming section 30 described below or a winding roll 51, so that the power of a conveyance roller (not shown) is not used.

In the above described long paper feeding section 15, the target recording medium (long paper) 16a is fed to the image forming section 30 via the paper guide roller 19, the lower paper conveyance roller pair 21, the auto cutter 22, and the upper paper conveyance roller pair 23 after passing under the paper guide roller 17 from the unwinder 25.

The image forming section 30 is an electrophotographic tandem-type color image forming apparatus using an intermediate transfer method, and includes a drum/developing device 31, a transfer belt device 32, a toner cartridge 33, an electric device section 34, a paper feeding section 35, a fixing device 36, and the like.

The toner cartridge 33 is arranged above the intermediate transfer belt 37 with the transfer belt device 32 being interposed therebetween, and the drum/developing device 31 is arranged substantially below the intermediate transfer belt 37. The transfer belt device 32 includes an intermediate transfer belt 37, a driving roller 38, and a driven roller 39. The drum/developing device 31 includes four developing devices 31k, 31c, 31m, and 31y provided side-by-side in multiple stages from the right to the left in FIG. 1 in contact with the lower traveling surface of the intermediate transfer belt 37 in the transfer belt device 32.

Toners in black (K), cyan (C), magenta (M), and yellow (Y) indicated by K, C, M, and Y in FIG. 1 are respectively supplied to the developing devices 31k, 31c, 31m, and 31y from four toner cartridges 33.

The toner cartridge 33 includes the four toner cartridges 33 respectively arranged above the upper traveling surface of the intermediate transfer belt 37. These four toner cartridges 33 respectively contain replenishing toners in black (K), cyan (C), magenta (M), and yellow (Y). In areas between these toner cartridges 33 and the drum/developing device 31, toner vertical conveyance paths 40 are respectively arranged, and a predetermined amount of toner is conveyed into the drum/developing device 31 from each toner cartridge 33.

The developing device 31 includes the four developing devices 31k, 31c, 31m, and 31y provided side-by-side in multiple stages, and all the developing devices 31k, 31c, 31m, and 31y respectively have the same structures except their toner colors for developing images. Among these developing devices 31k, 31c, 31m, and 31y, three developing devices 31c, 31m, and 31y on the upper flow side (the left side in FIG. 1) respectively form color images on the intermediate transfer belt 37 by using color toners in cyan (C), magenta (M), and yellow (Y) which are the subtractive primary colors, and the developing device 31k forms a monochrome image on the intermediate transfer belt 37 by using color toner in black (K) which is mainly used for a dark portion of a character and an image.

The transfer belt device 32 includes an endless intermediate transfer belt 37 positioned at a substantially central portion of the image forming section 30 and having a flat loop shape extending in a horizontal direction in FIG. 1, and a driving roller 38 and a driven roller 39 between which the intermediate transfer belt 37 is stretched and cyclically moved in the counterclockwise direction in FIG. 1.

The transfer belt device 32 further includes a secondary transfer backup roller 41 around which the intermediate transfer belt 37 is stretched above the driving roller 38, and a secondary transfer roller 42 is brought into pressure contact with this secondary transfer backup roller 41 via the intermediate transfer belt 37.

The target recording medium (long paper) 16a conveyed from the long paper feeding section 15 is pinched by the main body approach conveyance roller 47 and conveyed into the image forming section 30. When the target recording medium (long paper) 16a is conveyed into the image forming section 30, respective driving forces of the lower paper conveyance roller pair 21 and the upper paper conveyance roller pair 23 are turned off (disengaged), and the target recording medium (long paper) 16a is conveyed by the conveyance roller (the main body approach conveyance roller 47, etc.) in the image forming section 30.

The target recording medium (long paper) 16a is brought into pressure contact with the intermediate transfer belt 37 when it is conveyed between the secondary transfer backup roller 41 and the secondary transfer roller 42. As a result, respective color images with color toners in cyan (C), magenta (M), and yellow (Y) and a monochrome image with toner in black (K), which have been formed on the intermediate transfer belt 37, are sequentially transferred to the long paper serving as the target recording medium 16a, and fed into the fixing device 36.

Also, the paper feeding section 35 includes a sheet cassette having cut sheets placed therein. A cut sheet in the sheet cassette is conveyed to the secondary transfer backup roller 41 and the secondary transfer roller 42 located above via the paper feeding roller 44, as in the case of long paper. Then, respective color images with color toners in cyan (C), magenta (M), and yellow (Y) and a monochrome image with toner in black (K) formed on the intermediate transfer belt 37 are sequentially transferred to the cut sheet serving as the target recording medium 16a, and fed into the fixing device 36.

The fixing device 36 is a belt-type thermal fixing device, and fixes a toner image transferred to the target recording medium 16a that is long paper or a cut sheet. Long paper conveyed from the fixing device 36 is wrapped around the winding roll 51 installed in a long paper winding section 50 via a face-up unit 45. On the other hand, a cut sheet conveyed from the fixing device 36 is ejected to a paper ejection tray 46 placed on the upper surface of the fixing device 36.

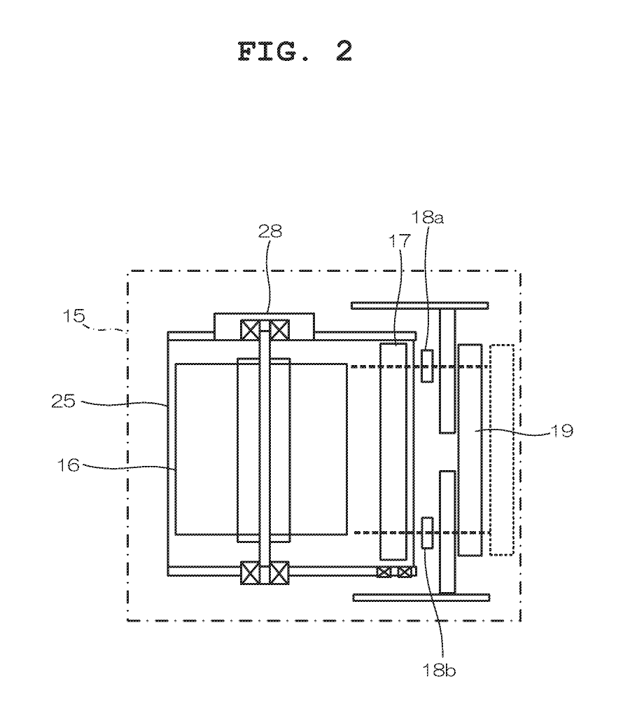

FIG. 2 is an upper view showing the structure of the long paper feeding section 15 in the image forming apparatus 10 according to the present embodiment. Note that sections corresponding to those of FIG. 1 are provided the same reference numerals, and explanations thereof are omitted. The edge sensors 18a and 18b are arranged between the paper guide roller 17 and the paper guide roller 19, and detect an edge of the target recording medium (long paper) 16a in the paper width direction. Examples of the edge sensors 18a and 18b include an optical sensor which detects reflected light/transmitted light and an ultrasonic sensor which detects a transmitted wave of an ultrasonic wave.

The unwinder 25 containing the paper feeding roll 16 is movable in the paper width direction by the actuator 27, and a control section 66 described below always moves the unwinder 25 in the paper width direction such that the edges in the paper width direction of the target recording medium (long paper) 16a respectively pass through detection ranges of the edge sensors 18a and 18b so that the target recording medium (long paper) 16a is always conveyed to a predetermined position.

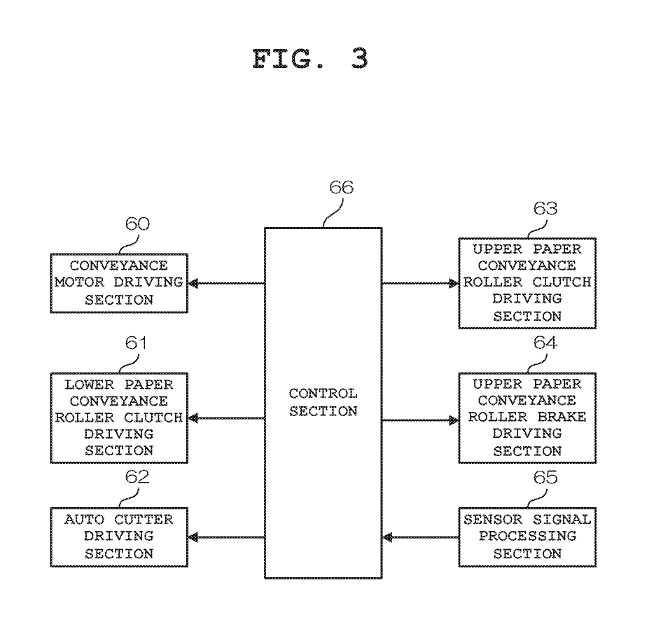

FIG. 3 is a block diagram showing a partial structure of a control system (the electric device section 34) in the image forming apparatus 10 according to the present embodiment. Note that sections corresponding to those of FIG. 1 are provided with the same reference numerals, and explanations thereof are omitted. In FIG. 3, the image forming apparatus 10 includes a conveyance motor driving section 60, a lower paper conveyance roller clutch driving section 61, an auto cutter driving section 62, an upper paper conveyance roller clutch driving section 63, an upper paper conveyance roller brake driving section 64, a sensor signal processing section 65, and the control section 66.

The conveyance motor driving section 60 drives a conveyance roller provided in the long paper feeding section 15 for feeding the target recording medium (long paper) 16a from the paper feeding roll 16 according to an instruction from the control section 66, and the lower paper conveyance roller clutch driving section 61 turns on/off the clutch mechanism in the lower paper conveyance roller pair 21 according to an instruction form the control section 66. The auto cutter driving section 62 drives the auto cutter 22 to cut the target recording medium (long paper) 16a when the paper feeding roll 16 is placed to feed the target recording medium (long paper) 16a or when the printing is ended, according to an instruction from the control section 66.

The upper paper conveyance roller clutch driving section 63 turns on/off the clutch mechanism in the upper paper conveyance roller pair 23 according to an instruction from the control section 66. The upper paper conveyance roller brake driving section 64 controls an excitation current to the power brake mechanism in the upper paper conveyance roller pair 23 so as to adjust a load torque to be applied to the upper paper conveyance roller pair 23, according to an instruction from the control section 66. More specifically, the control section 66 and the upper paper conveyance roller brake driving section 64 operate as a current adjustment device which adjusts an excitation current of a powder brake. The sensor signal processing section 65 performs processing such as processing for converting a signal from the paper passage sensor 24, which detects the passage of the front edge or the rear edge of the target recording medium (long paper) 16a, into digital data.

The control section 66 integrates the respective operations of the above-described sections to perform control. Particularly, in the present embodiment, the control section 66 controls driving of a conveyance motor (not shown) in the long paper feeding section 15, controls on/off of the respective clutch mechanisms in the lower paper conveyance roller pair 21 and the upper paper conveyance roller pair 23, controls the powder brake mechanism in the upper paper conveyance roller pair 23, and controls the operation of the auto cutter 22 at predetermined timing when the auto cutter 22 cuts the target recording medium (long paper) 16a.

### B. Operation of Embodiment

Next, an operation of the present embodiment is described.

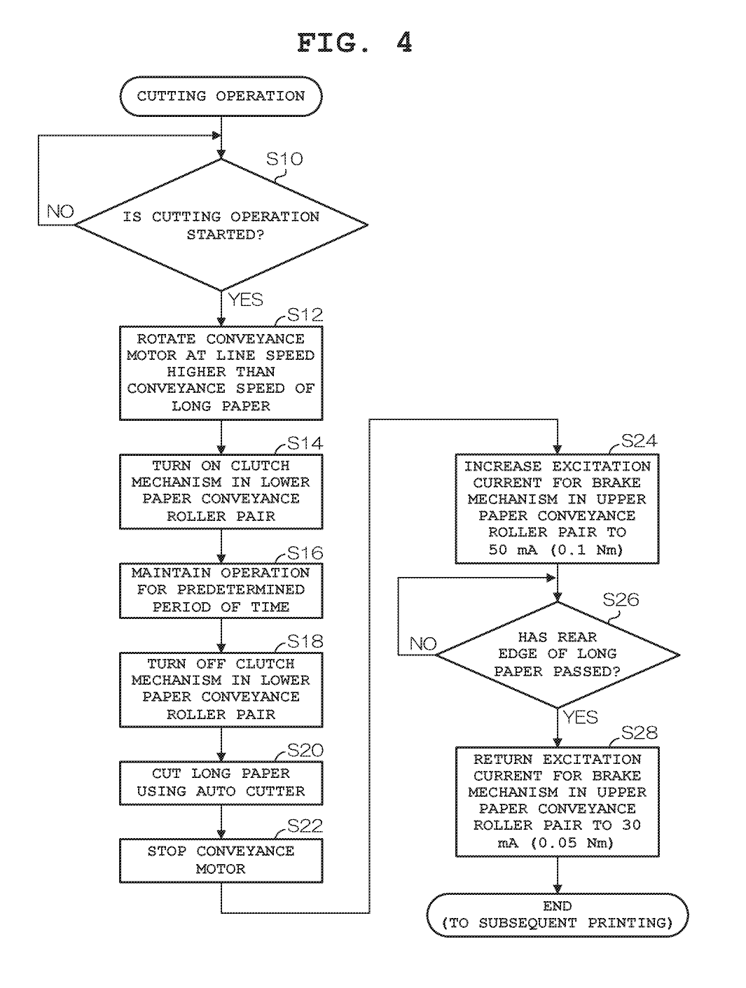

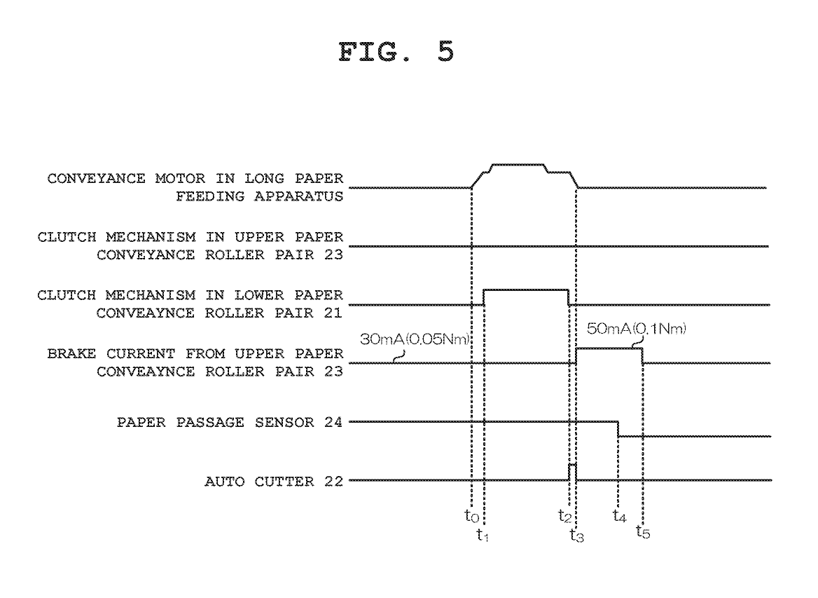

FIG. 4 is a flowchart for explaining an operation (cutting operation) of the image forming apparatus 10 according to the present embodiment, and FIG. 5 is a timing chart for explaining the operation (cutting operation) of the image forming apparatus 10 according to the present embodiment.

First, a state of each section before the cutting of the target recording medium (long paper) 16a is described. In FIG. 5, before time t0, the target recording medium (long paper) 16a has not been cut. Here, the target recording medium (long paper) 16a, which is being subjected to printing, is being conveyed by the main body approach conveyance roller 47, and the conveyance motor in the long paper feeding section 15 is in a stopped state. Also, the clutch mechanism in the lower paper conveyance roller pair 21 is off, and the clutch mechanism in the upper paper conveyance roller pair 23 is also off. In addition, an excitation current of 30 mA (corresponding to 0.05 Nm) is flowing through the powder brake mechanism in the upper paper conveyance roller pair 23, and tension is being applied to the target recording medium (long paper) 16a on the lower flow side of the upper paper conveyance roller pair 23 through which the target recording medium (long paper) 16a passes, with a relatively low load torque.

Next, the operation for cutting the target recording medium (long paper) 16a is described. First, the control section 66 judges whether cutting operation start timing for the target recording medium (long paper) 16a has been reached (Step S10). Here, whether the cutting operation stat timing has been reached is judged based on the progress of a printing operation in the image forming section 30. Then, when the cutting operation start timing has not been reached (NO at Step S10), the control section 66 maintains a state before the cutting.

Conversely, when the cutting operation is started (YES at Step S10), the control section 66 causes the conveyance motor driving section 60 to drive the conveyance motor in the long paper feeding section 15 at time t0 shown in FIG. 5 so as to rotate the conveyance roller at a line speed higher than a conveyance speed of the target recording medium (long paper) 16a (Step S12), and causes the lower paper conveyance roller clutch driving section 61 to turn on the clutch mechanism in the lower paper conveyance roller pair 21 at time t1 shown in FIG. 5 (Step S14). As a result, a feeding speed from the long paper feeding section 15 becomes higher than the conveyance speed. The control section 66 maintains this state for a predetermined period of time (from time t1 to time t2 shown in FIG. 5) (Step S16).

Since the feeding speed from the long paper feeding section 15 is higher than the conveyance speed, the target recording medium (long paper) 16a is curved in an area between the lower paper conveyance roller pair 21 and the upper paper conveyance roller pair 23. The target recording medium (long paper) 16a is curved herein so as not to affect an operation in a secondary transfer section on the lower flow side of a cutting position, as described above. Here, the excitation current to the powder brake mechanism in the upper paper conveyance roller pair 23 is maintained at 30 mA (corresponding to 0.05 Nm) so that the target recording medium (long paper) 16a is not pushed in by a curving force in the upper paper conveyance roller pair 23 which is rotating while being driven. More specifically, when a predetermined load torque is applied to the powder brake mechanism in the upper paper conveyance roller pair 23, tension continues to be applied to the target recording medium (long paper) 16a on the lower flow side of the upper paper conveyance roller pair 23.

Then, when the cutting position reaches the auto cutter 22 after a predetermined period of time, the control section 66 turns off the clutch mechanism in the lower paper conveyance roller pair 21 at time t2 in FIG. 5 (Step S18). When the clutch mechanism in the lower paper conveyance roller pair 21 is turned off, the feeding of the target recording medium (long paper) 16a is stopped. Then, the control section 66 causes the auto cutter driving section 62 to drive the auto cutter 22 to cut the target recording medium (long paper) 16a at time t3 shown in FIG. 5 with the target recording medium (long paper) 16a being curved and stopped in the area between the lower paper conveyance roller pair 21 and the upper paper conveyance roller pair 23 (Step S20).

Then, immediately after the target recording medium (long paper) 16a is cut by the auto cutter 22, the control section 66 causes the conveyance motor driving section 60 to stop the conveyance motor in the long paper feeding section 15 at time t3 in FIG. 5 (Step S22). As a result, the feeding of the target recording medium (long paper) 16a is stopped. Note that the target recording medium (long paper) 16a that is being subjected to printing, i.e., the target recording medium (long paper) 16a on the side of winding around the winding roll 51 is conveyed toward the lower flow side because the printing is being continued (secondary transfer and fixation).

Also, the control section 66 causes the upper paper conveyance roller brake driving section 64 to increase the excitation current for the powder brake mechanism in the upper paper conveyance roller pair 23 to 50 mA (corresponding to 0.1 Nm) at time t3 in FIG. 5 immediately after the cutting of the target recording medium (long paper) 16a (Step S24). More specifically, the load torque of the powder brake mechanism in the upper paper conveyance roller pair 23 is made higher than a predetermined load torque during normal conveyance. When the excitation current to the powder brake mechanism in the upper paper conveyance roller pair 23 is thus increased to increase the load torque immediately after the cutting of the target recording medium (long paper) 16a, tension larger than usual is applied to the target recording medium (long paper) 16a on the lower flow side of the upper paper conveyance roller pair 23 so as to prevent a rear edge of paper after the cutting from being unstable and to prevent an image disturbance and a crease from occurring.

Then, the control section 66 judges whether the rear edge of the target recording medium (long paper) 16a wrapped around the winding roll 51 has passed through the paper passage sensor 24 based on a detection signal of the paper passage sensor 24 from the sensor signal processing section 65 (Step S26). When judged that the rear edge of the target recording medium (long paper) 16a has not passed through the paper passage sensor 24 (NO at Step S26) as shown in FIG. 5 from time t3 to time t4, the control section 66 maintains the excitation current for the powder brake mechanism in the upper paper conveyance roller pair 23 at 50 mA (corresponding to 0.1 Nm). More specifically, the control section 66 continues to prevent the rear edge of paper after the cutting from being unstable, by maintaining the load torque of the powder brake mechanism in the upper paper conveyance roller pair 23 at a value larger than the predetermined load torque during normal conveyance.

Conversely, when judged that the rear edge of the target recording medium (long paper) 16a wrapped around the winding roll 51 has passed through the paper passage sensor 24 (YES at Step S26) at time t4 shown in FIG. 5, the control section 66 causes the upper paper conveyance roller brake driving section 64 to return the excitation current for the powder brake mechanism in the upper paper conveyance roller pair 23 to 30 mA (corresponding to 0.05 Nm) (Step S28). More specifically, the control section 66 returns the load torque of the powder brake mechanism in the upper paper conveyance roller pair 23 to a predetermined load torque during normal conveyance. Then, the control section 66 stays in this state until the next printing instruction is given, so that the target recording medium (long paper) 16a that is fed from the paper feeding roll 16 in response to the next printing instruction is prevented from being pushed in by a curving force in the upper paper conveyance roller pair 23 when it is cut, as described above. Accordingly, if the subsequent printing instruction is not given even after a predetermined period of time, the excitation current to the powder brake mechanism in the upper paper conveyance roller pair 23 may be set to 0 mA.

According to the above-described embodiment, the upper paper conveyance roller pair 23 on the lower flow side of the auto cutter 22 includes the power brake mechanism. After the auto cutter 22 cut the target recording medium (long paper) 16a, when the powder brake mechanism adjusts the load torque to be applied to the upper paper conveyance roller pair 23, that is, adjusts the tension of the target recording medium (long paper) 16a on the lower flow side of the upper paper conveyance roller pair 23, the rear edge of the paper after the cutting can be prevented from being unstable, whereby image disturbance and creases do not occur.

Also, according to the above-described embodiment, when the target recording medium (long paper) 16a, which has not been cut, is pinched, a load torque of a predetermined magnitude is applied to the upper paper conveyance roller pair 23 by supplying 30 mA (0.05 Nm) as the excitation current to the powder brake mechanism so as to apply tension of a predetermined magnitude to the target recording medium (long paper) 16a pinched by the upper paper conveyance roller pair 23. When the target recording medium (long paper) 16a, which has been cut, is pinched, a load torque higher than the predetermined load torque is applied by supplying 50 mA (0.1 Nm) as the excitation current to the powder brake mechanism so as to apply high tension to the target recording medium (long paper) 16a pinched by the upper paper conveyance roller pair 23. Therefore, useless energy is not consumed compared to when high tension is applied from the beginning, and the rear edge of the paper after the cutting can be prevented from being unstable, whereby image disturbance and creases do not occur. That is, when a relatively large excitation current is supplied to the powder brake mechanism in the upper paper conveyance roller pair 23 from the beginning and a high load torque (second load torque) is generated, useless energy is consumed. However, by the load torque being adjusted corresponding to the timing of the cutting, waste energy consumption is suppressed.

Moreover, according to the above-described embodiment, when the rear edge of the target recording medium (long paper) 16a, which has been cut, passes through the upper paper conveyance roller pair 23, the power brake mechanism returns the load torque to be applied to the upper paper conveyance roller pair 23 to a relatively low load torque in a normal operation. Thus, the target recording medium (long paper) 16a can be smoothly conveyed in the subsequent printing operation.

Furthermore, according to the above-described embodiment, the power brake mechanism for applying a braking force to the driven rotation of the upper paper conveyance roller pair 23 adjusts the load torque to be applied to the upper paper conveyance roller pair 23. That is, the present embodiment can be achieved by a simpler structure.

In the above-described embodiment, immediately after the target recording medium (long paper) 16a is cut, the load torque to the driven rotation of the upper paper conveyance roller pair 23 is increased until the rear edge of the target recording medium (long paper) 16a passes through the upper paper conveyance roller pair 23 so as to apply tension larger than usual to the target recording medium (long paper) 16a. However, the load torque to the driven rotation of the upper paper conveyance roller pair 23 may be changed based on the type and the size of the target recording medium (long paper) 16a. Generally, when a target recording medium (long paper) is thick or the paper width thereof is larger, the rear edge of paper after cutting of the target recording medium (long paper) tends to be more greatly unstable. Accordingly, for example, when the target recording medium (long paper) 16a is thicker, the load torque (tension) is made higher. Alternatively, when the paper width of the target recording medium (long paper) 16a is longer, the load torque (tension) is made higher. As a result of this configuration, the rear edge of paper after cutting can be more effectively prevented from being unstable based on the type and the size of the target recording medium (long paper) 16a, whereby image disturbance and creases can do not occur.

Also, in the above-described embodiment, the load torque to the driven rotation of the upper paper conveyance roller pair 23 is adjusted by varying the excitation current of the powder brake mechanism provided in the upper paper conveyance roller pair 23. However, the present invention is not limited thereto. Another means and method may be used as long as the load torque to the driven rotation of the upper paper conveyance roller pair 23 can be varied. For example, the load torque (the tension of the target recording medium thereby) may be varied by changing a pinching force itself of the upper paper conveyance roller pair 23 (a pressure bonding force between the rollers).

While the present invention has been described with reference to the preferred embodiments, it is intended that the invention be not limited by any of the details of the description therein but includes all the embodiments which fall within the scope of the appended claims.

What is claimed is:

1. A target recording medium feeding apparatus which feeds a target recording medium to an image forming section, comprising:
a cutting section which cuts the target recording medium at a predetermined position in a conveyance path through which the target recording medium is conveyed;
a load application section which applies load tension to the target recording medium on a lower flow side of the predetermined position in the conveyance path; and
an adjustment section which adjusts the load tension in a manner to correspond to cut timing.

2. The target recording medium feeding apparatus according to claim 1, wherein the adjustment section adjusts the load tension such that the load tension is increased corresponding to the cut timing.

3. The target recording medium feeding apparatus according to claim 2, wherein the adjustment section adjusts the load tension based on a type or size of the target recording medium.

4. The target recording medium feeding apparatus according to claim 1, wherein the adjustment section adjusts the load tension based on a type or size of the target recording medium.

5. A target recording medium feeding apparatus which feeds a target recording medium to an image forming section, comprising:
a cutting section which cuts the target recording medium at a predetermined position in a conveyance path through which the target recording medium is conveyed;
a target recording medium pinching section which pinches the target recording medium on a lower flow side of the predetermined position in the conveyance path, and rotates while being driven by the conveyed target recording medium;
a load application section which applies a load torque to driven rotation of the target recording medium; and
an adjustment section which adjusts the load torque in a manner to correspond to cut timing.

6. The target recording medium feeding apparatus according to claim 5, wherein the adjustment section adjusts the load torque such that the load torque is increased corresponding to the cut timing.

7. The target recording medium feeding apparatus according to claim 6, wherein the adjustment section adjusts the load torque based on a type or size of the target recording medium.

8. The target recording medium feeding apparatus according to claim 5, wherein the load application section includes a braking section which is provided in at least one roller in the target recording medium pinching section and applies a braking force to driven rotation of the one roller.

9. The target recording medium feeding apparatus according to claim 8, wherein the braking section is a powder brake which continuously varies a transmission torque based on an excitation current value so as to brake the driven rotation of the one roller.

10. The target recording medium feeding apparatus according to claim 9, wherein the adjustment section adjusts the load torque based on a type or size of the target recording medium.

11. The target recording medium feeding apparatus according to claim 5, wherein the adjustment section adjusts the load torque based on a type or size of the target recording medium.

12. The target recording medium feeding apparatus according to claim 8, wherein the adjustment section adjusts the load torque based on a type or size of the target recording medium.

13. An image forming apparatus comprising:
a cutter which cuts a target recording medium at a predetermined position in a conveyance path through which the target recording medium is conveyed;
a conveyance roller pair which pinches the target recording medium on a lower flow side of the predetermined position in the conveyance path, and rotates while being driven by the conveyed target recording medium;
a powder brake which applies a load torque based on an excitation current to driven rotation of the conveyance roller pair; and
a current adjustment device which adjusts the excitation current in a manner to correspond to cut timing.

14. The image forming apparatus according to claim 13, wherein the current adjustment device adjusts the excitation current such that the load torque is increased corresponding to the cut timing.

15. The image forming apparatus according to claim 14, wherein the current adjustment device adjusts the excitation current based on a type or size of the target recording medium.

16. The image forming apparatus according to claim 13, wherein the current adjustment device adjusts the excitation current based on a type or size of the target recording medium.

17. A target recording medium cutting control method for cutting a target recording medium, comprising:
a step of cutting the target recording medium at a predetermined position in a conveyance path through which the target recording medium is conveyed, by a cutting section; and
a step of adjusting tension of the target recording medium to be applied on a lower flow side of the predetermined position in the conveyance path in a manner to correspond to cut timing.

18. The target recording medium cutting control method according to claim 17, wherein the adjusting step adjusts the tension of the target recording medium based on a type or size of the target recording medium.

19. A target recording medium cutting control method for cutting a target recording medium to be fed to an image forming section, comprising:
a step of cutting the target recording medium at a predetermined position in a conveyance path through which the target recording medium is conveyed, by using a cutter; and
a step of pinching the target recording medium on a lower flow side of the predetermined position in the conveyance path, and adjusting an excitation current of a powder brake which applies a load torque based on the excitation current to a conveyance roller pair which rotates while being driven by the conveyed target recording medium, in a manner to correspond to cut timing.

20. The target recording medium cutting control method according to claim 19, wherein the adjusting step adjusts the excitation current based on a type or size of the target recording medium.
